(19) United States
(12) Patent Application Publication
(10) Pub. No.: US 2009/0157829 A1
(43) Pub. Date: Jun. 18, 2009

(54) Peer-to-peer service system and method using e-mail service

(75) Inventors: Moon-Ok Choi, Chungcheongbuk-do (KR); Il-Woo Lee, DaeJeon (KR); Sang-Bong Lee, DaeJeon (KR); Ho-Jin Park, DaeJeon (KR); Hae-Ryong Lee, DaeJeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/155,459

(22) Filed: Jun. 4, 2008

(30) Foreign Application Priority Data
Dec. 14, 2007 (KR) 10-2007-131203

(51) Int. Cl. G06F 15/16

(52) U.S. Cl. 709/206

(57) ABSTRACT

A peer-to-peer service method and system are provided. The peer-to-peer service method include advertising E-mail address information and service and sharing resource information through a peer-to-peer network at peers, determining whether a peer requesting a service and a peer providing the service are in online state or in offline state on the peer-to-peer network, and providing a peer-to-peer service through an E-mail server when the peer requesting the service or the peer providing the service is in offline state. The peer-to-peer service system and method using an E-mail service are capable of providing a variety of P2P services (e.g., a message exchange, a file exchange, a remote control, etc.) to peers, which are in online state or temporarily in offline state, by using the E-mail in the P2P network environment which manages the connection information of the peers joined to the corresponding service or the indexes of the sharing resources.

### CROSS-REFERENCE TO RELATED APPLICATIONS

This application claims priority under 35 U.S.C. §119 to Korean Patent Application No. 10-2007-131203, filed on Dec. 14, 2007 the disclosure of which is incorporated herein by reference in its entirety.

### BACKGROUND OF THE INVENTION

1. Field of the Invention

The present disclosure relates to a peer-to-peer (P2P ) service system and method using an E-mail service, and more particularly, to a P2P service system and method using an E-mail service, which are capable of providing a variety of P2P services (e.g., a message exchange, a file exchange, a remote control, etc.) to peers, which are in online state or temporarily in offline state, by using the E-mail in the P2P network environment which manages the connection information of the peers joined to the corresponding service or the indexes of the sharing resources.

2. Description of the Related Art

Recently, as the performances of personal terminals, such as desktop PCs, portable notebook computers, personal digital assistants (PDAs), portable multimedia players (PMPs), and mobile phones, are improved and the ultra-high-speed wired/wireless Internet environment are developed, a P2P service architecture that can enable each terminal to function as both a server and a client is replaced with an existing server-client architecture.

An instant messenger service and a file sharing service are widely used as the P2P application services. In addition, a variety of application services using a P2P network, such as a distributed computing, a remote device control or a remote process control, are under development.

The P2P application services constructs individual P2P overlay networks and provide services based on the individual P2P overlay networks. The P2P overlay network architectures may be classified into hybrid P2P networks and pure P2P networks according to existence or non-existence of a central server.

The hybrid P2P network includes a central server that manages peer connection information and metadata directory of service and sharing resources. The hybrid P2P network is widely used in a general file sharing service. That is, peer connection information or metadata of sharing resources held in peers are centralized and managed in the central server. When an arbitrary peer connects to the central server and makes a search request of a specific service or sharing resource, the central server causes a peer holding the requested sharing resource to provide the corresponding service or sharing resource through a P2P direct connection to the peer requesting the sharing resource.

The hybrid P2P network can quickly search the service or sharing resource because the metadata are managed by the central server. On the contrary, since the responsibility for the P2P network operation is centralized in the central server, the hybrid P2P network has a single point of failure or a scalability problem caused by the increase of participating peers. The single point of failure includes a system error of the central server or a failure to connect to the central server, making the entire P2P network server unavailable.

The pure P2P network does not particularly define the existence of the central server. That is, the metadata that are managed by the central server in the hybrid P2P network architecture are distributed and managed by some peers or all peers. A search query request message for a specific service or sharing resource, which is generated by an arbitrary peer, is transmitted to neighbor connectable peers, and the query request message is propagated through the P2P network in accordance with a mechanism provided in a P2P infrastructure constructing an overlay network. CAN, Chord, and Pastry are used as the P2P infrastructure. A peer holding the requested service or sharing resource among the peers receiving the query message provides the corresponding service or sharing resource through a direct connection to the peer that initially requests the service or sharing resource.

Compared with the hybrid P2P network architecture, the pure P2P network architecture propagates the query in a relatively complicated manner and thus the sharing resources are not quickly searched. However, since no additional central server exists, the pure P2P network architecture solves the single point of failure problem, which is a fatal error in providing the service. Furthermore, the pure P2P network architecture can solve the scalability problem associated with the performance degradation problem caused by the increase in the number of joined peers. Accordingly, the pure P2P network architecture is used in Gnutella or JXTA based P2P application services.

General elements of the pure P2P network are as follows.

Peer: A peer is a node on a P2P network and can be classified into an edge peer, a rendezvous peer, and a router peer according to its role. The edge peer can provide a service to another peer on the P2P network or receive a service from another peer. The rendezvous peer plays a role of the edge peer and also propagates a query for searching sharing resources on the P2P network. The router peer provides a mechanism for communication with a peer separated from the network by firewall or network address translation (NAT).

Peer group: A peer group is a group of peers constructed for the purpose of sharing a specific service on the P2P network. The peer group needs an additional joining procedure. Thus, a peer that is not joined to a corresponding peer group cannot share a service provided from the peer group. The JXTA provides a mechanism for constructing and operating the peer group.

Advertisement: An advertisement is a message that is generated by peers participating in the P2P network and propagated in the P2P network. The peer, the peer group, the service, and the sharing resource are represented in a structured message format using an extensible Markup Language (XML). A query propagated in the P2P network by a specific peer is responded as the advertisement.

P2P network transmission: A P2P network transmission is a mechanism for providing a data communication channel between two peers on the P2P network. There are two types of P2P network transmission: a low level transmission such as Transmission Control Protocol (TCP) or User Datagram Protocol (UDP), and a high level transmission such as Hypertext Transfer Protocol (HTTP) or Simple Mail Transfer Protocol (SMTP). Representative messages exchanged through the P2P network transmission are a request message and a response message.

The application service based on the pure P2P network has advantages in that the central server does not exist, but has disadvantages in that a service is available only between peers that are in online state. That is, in one implementation of the file sharing service based on the hybrid P2P network, copies of files shared by peers are stored in the central server and then the sharing service of the files stored in the central server can be provided when a corresponding peer is in offline state.

In the file sharing service based on the pure P2P network, however, the file sharing is impossible when a peer holding a file searched by a specific peer is in offline state.

### SUMMARY

Therefore, an object of the present invention is to provide a P2P service system and method using an E-mail service, which are capable of providing a variety of P2P services (e.g., a message exchange, a file exchange, a remote control, etc.) to peers, which are in online state or temporarily in offline state, by using the E-mail in the P2P network environment which manages the connection information of the peers joined to the corresponding service or the indexes of the sharing resources.

To achieve these and other advantages and in accordance with the purpose(s) of the present invention as embodied and broadly described herein, a peer-to-peer service method in accordance with an aspect of the present invention includes: advertising E-mail address information and service and sharing resource information through a peer-to-peer network at peers; determining whether a peer requesting a service and a peer providing the service are in online state or in offline state on the peer-to-peer network; and providing a peer-to-peer service through an E-mail server when the peer requesting the service or the peer providing the service is in offline state.

Prior to the advertising operation, the peer-to-peer service method may further include registering an E-mail server address and a corresponding E-mail address at the respective peers on the peer-to-peer network. The E-mail address information and the service and sharing resource information may be advertised when a corresponding peer-to-peer application service is initialized, contents of the service and sharing resource are changed, or there is a request from a user of the peer-to-peer application service.

A specific service and sharing resource information may be transmitted through a peer-to-peer direct connection when the peer requesting the service and the peer providing the service are in online state.

When the peer requesting the service is in online state, an operation of requesting a specific service or sharing resource may include: searching a specific service or sharing resource advertisement on the peer-to-peer network; determining whether a peer providing a service and sharing resource is in online state or in offline state by using a peer-to-peer direct connection address contained in the searched advertisement; creating an E-mail having E-mail contents and an E-mail header defined in the peer-to-peer application service when the peer proving the service and sharing resource is in offline state, the E-mail contents including a service and sharing resource request message, peer-to-peer direct connection information of the peer requesting the service and sharing resource, an E-mail address of the peer requesting the service and sharing resource, and maximum response deadline information; and transmitting the created E-mail to an E-mail address contained in the searched advertisement.

The service and sharing resource request message may be directly transmitted through the peer-to-peer direct connection when the peer providing the service and sharing resource is in online state. The peer-to-peer service method may further include: downloading an E-mail from an E-mail server designated by a user to a local peer when the peer on the peer-to-peer network changes from offline state to online state; filtering an E-mail containing an E-mail header defined by the corresponding peer-to-peer application service; and extracting a request message or a response message for service and sharing resource request from the filtered E-mail, and extracting peer-to-peer direct connection information of the requesting peer and an E-mail address information of the requesting peer from the request message whose maximum response period has not passed.

The extracting of the request message may include: performing an authentication procedure when authentication information related to providing the service and sharing resource is contained; and performing a decryption procedure when peer-to-peer E-mail contents are encrypted.

After the extracting of the request message, the peer-to-peer service method may further include: executing a service when a requested content of the extracted request message is the service; generating the response message containing the execution result of the requested service or the requested sharing resource; determining whether the peer requesting the service and sharing resource is in online state or in offline state by using the peer-to-peer direct connection address information contained in the request message; and generating the response message having an E-mail header and a mail format defined by the peer-to-peer application service when the peer requesting the service and sharing resource is in online state, and transmitting the generated response message to an E-mail address of the request message.

The peer-to-peer service method may further include directly transmitting the response message through the peer-to-peer direct connection when the peer requesting the service and sharing resource is in online state.

To achieve these and other advantages and in accordance with the purpose(s) of the present invention, a peer-to-peer service system in accordance with another aspect of the present invention includes: a first peer for requesting service and sharing resource information provided on a peer-to-peer network; a second peer for providing the requested service and sharing resource on the peer-to-peer network; a first mail server for registering an E-mail address of the first peer, receiving the service and sharing resource transmitted from the second peer when the first peer is in offline state, and transmitting the service and sharing resource information to the first peer when the first peer changes from offline state to online state; and a second mail server for registering an E-mail address of the second peer, receiving a requested mail from the first peer when the second peer is in offline state, and transmitting the requested mail to the second peer when the second peer changes from offline state to online state.

The first peer and the second peer may advertise service and sharing resource to be provided on the peer-to-peer network, peer-to-peer direct connection address information, and E-mail address information. The advertisement may be generated and propagated when a corresponding peer-to-peer application service is initialized, the service and sharing resource to be provided on the peer-to-peer network is changed, or there is a request from a user of the peer-to-peer application service. The advertisement may be propagated within a predetermined expiration time defined by the peer-to-peer application service.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates an architecture of a P2P service system using an E-mail service according to an embodiment of the present invention;

FIGS. 2A through 2D illustrate the states of the P2P services of FIG. 1;

FIG. 3 is a flowchart illustrating a P2P service method using an E-mail service according to an embodiment of the present invention; and

FIG. 4 is a flowchart illustrating a P2P service method using an E-mail service when a peer on the P2P network changes from offline to online.

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

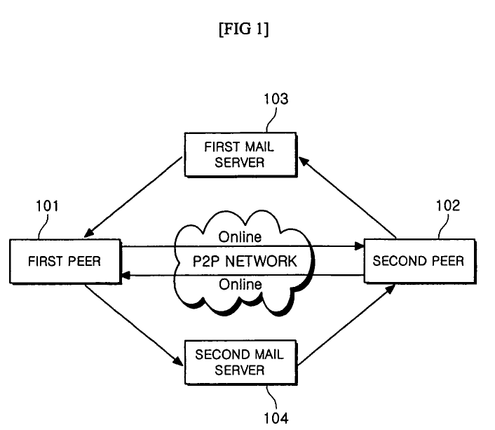

FIG. 1 illustrates an architecture of a P2P service system using an E-mail service according to an embodiment of the present invention. Referring to FIG. 1, the P2P service system includes a first peer 101, a second peer 102, a first mail server 103, and a second mail server 104. The first peer 101 requests service and sharing resource information provided on a P2P network, and the second peer 102 provides the requested service and sharing resource information on the P2P network. The second mail server 104 registers an E-mail address of the second peer 102, receives a requested mail from the first peer 101 when the second peer 102 is in offline state, and transmits the requested mail to the second peer 102 when the second peer 102 changes from offline state to online state. The first mail server 103 registers an E-mail address of the first peer 101, receives the service and sharing resource information from the second peer 102 when the first peer 101 is in offline state, and transmits the service and sharing resource information to the first peer 101 when the first peer 101 changes from offline state to online state.

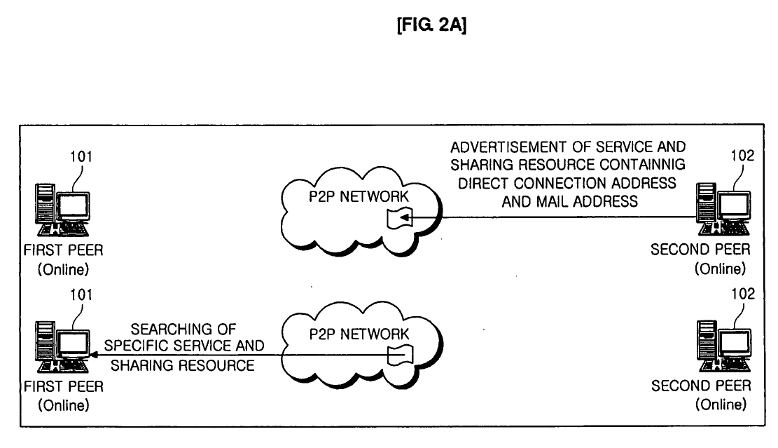

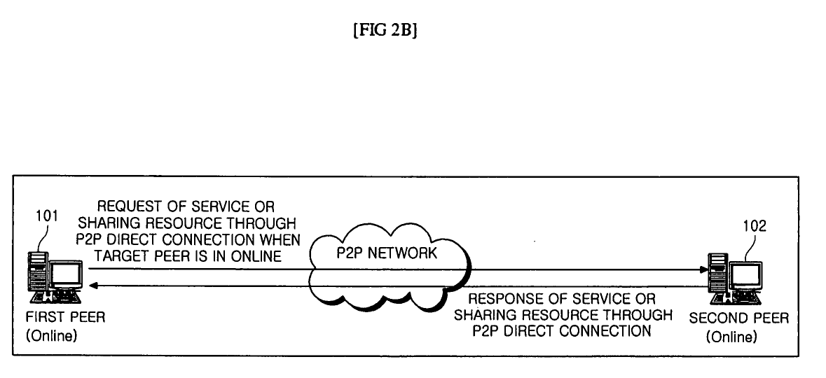

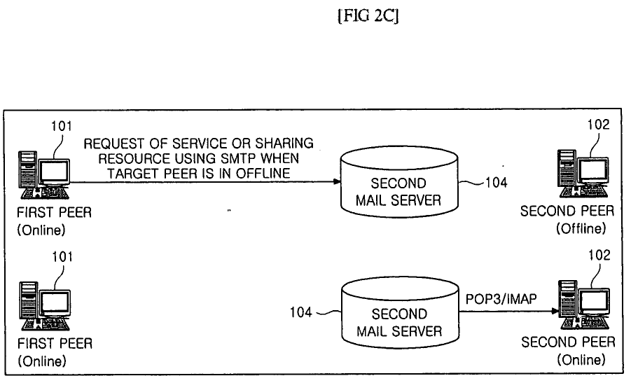

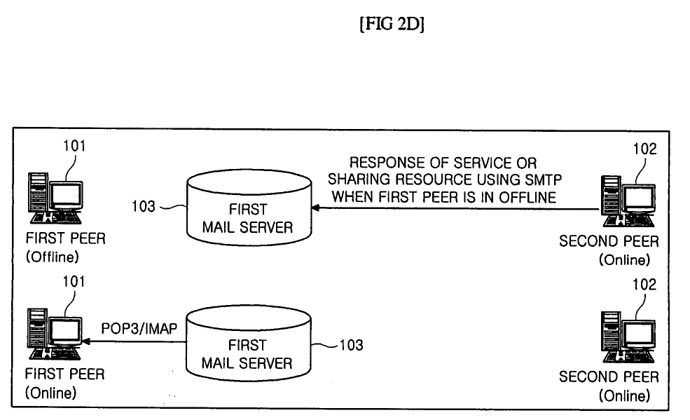

FIGS. 2A through 2D illustrate the states of the P2P services of FIG. 1. Specifically, FIG. 2A illustrates an advertisement of a peer providing service and sharing resource on the P2P network. The second peer 102 providing a service constructs an advertisement with the corresponding service and sharing resource information, a connection address, which will be used in a P2P direct connection, and an E-mail address, which will be used when the second peer 102 is in offline state, and publishes the constructed advertisement on the P2P network.

At this point, the advertisement is generated and propagated when a corresponding P2P application service is initialized, the service and resource information is changed, and a user of the P2P application service requests. (to generate and propagate the advertisement) The advertisement is propagated within a predetermined expiration time defined by the P2P application service.

In addition, the first peer 101 requesting a service searches service and sharing resource information on the P2P network and requests service and sharing resource information provided by the second peer 102.

Referring to FIG. 2B, when the first peer 101 requesting the service and sharing resource and the second peer 102 providing the service and sharing resource are simultaneously in online state, a request message or a response message for the corresponding service and sharing resource is directly transmitted through the P2P connection using the P2P direct connection address contained in the advertisement.

Referring to FIG. 2C, when the second peer 102 providing the service and sharing resource is in offline state, the first peer 101 requesting the service and sharing resource transmits a request message for the corresponding service and sharing resource to the second mail server 104 through Simple Mail Transfer Protocol (SMTP) using the E-mail address contained in the advertisement.

In the above procedure, when the second peer 102 changes from offline state to online state, the second mail server 104 transmits the received message to the second peer 102 using Post Office Protocol version 3 (POP3) or Internet Messaging Access Protocol (IMAP).

Referring to FIG. 2D, when the first peer 101 requesting the service and sharing resource is in offline state, the second peer 102 providing the service and sharing resource transmits a response message to the first mail server 103 through SMTP using the E-mail address contained in the request message.

In the above procedure, when the first peer 101 changes from offline state to online state, the first mail server 103 transmits the received message to the first peer 101 using POP3 or IMAP.

Although it has been described that the first peer 101 and the second peer 102 serve as the peer requesting the service and the peer providing the service, respectively, it is only for convenience of explanation of peers on the P2P network, and the present invention is not limited to the above embodiments.

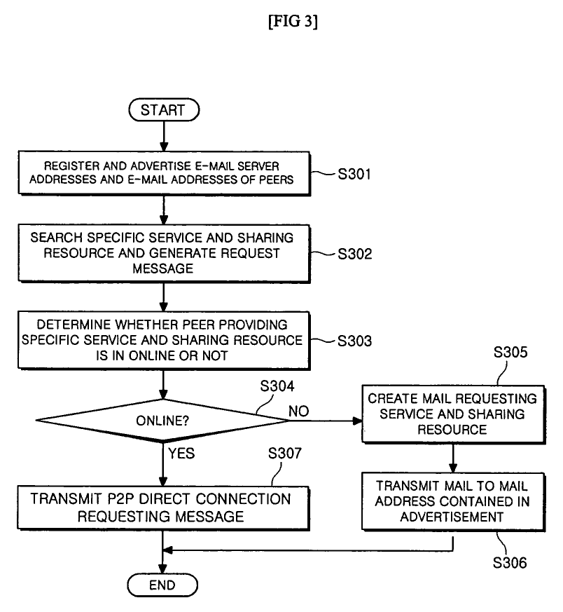

FIG. 3 is a flowchart illustrating a P2P service method using an E-mail service according to an embodiment of the present invention. Referring to FIG. 3, all peers on the P2P network register and manage addresses of E-mail servers supporting POP3 or IMAP in the P2P application service, and E-mail addresses of users registered in the corresponding E-mail servers in operation S301.

The advertisement containing the services or sharing resource information provided on the P2P network by the corresponding peers, the P2P direct connection information, and the E-mail address information set in the registering operation are generated and propagated in the P2P network.

Preferably, the generation and propagation of the advertisement are performed when the corresponding P2P application service is initialized, contents of the service and sharing resource to be provided on the P2P network are changed, or there is a request from a user of the P2P application service.

The generated advertisement has a predetermined expiration time defined by the P2P application service. An advertisement whose expiration time has passed is not propagated on the P2P network any more.

In addition, the service provided by the corresponding peer on the P2P network means executing a specific program or process using a central processing unit (CPU) and providing the execution result. Such a service can be used in application services, such as a distributed computing, a P2P remote device control, and a P2P remote process control.

The sharing resource provided by the corresponding peer on the P2P network refers to data stored in a computer storage in various file formats, such as a multimedia file and a text file. Typically, the sharing resource can be used in a P2P file sharing application service.

In operation S302, the peer requesting the service on the P2P network searches a specific service and sharing resource and generates a request message.

More specifically, the peer queries and searches an advertisement containing information coinciding with the specific service or sharing resource through the P2P network, and generates a service and sharing resource request message containing the P2P direct connection information of the requesting peer and the E-mail address information of the requesting peer in accordance with the format defined in the P2P application service.

In operation S303, the peer tries the P2P direct connection to the peer publishing the searched advertisement and determines whether the target peer providing the service is in online state or not.

When it is determined that the target peer is in offline state in operation S304, the peer creates an E-mail including E-mail contents and an E-mail header having a format defined by the P2P application service. The E-mail contents include the generated service and sharing resource request message, the P2P direct connection information of the requesting peer, the E-mail address information of the requesting peer, maximum response deadline information, and authentication information.

The E-mail may include authentication information related to providing the service and sharing resource according to the setup of the P2P application service, and the E-mail contents created according to the setup of the P2P application service may be encrypted.

In operation S306, the created E-mail is transmitted to the E-mail address contained in the searched advertisement using SMTP.

Meanwhile, when it is determined that the target peer is in online state in operation S304, the service or sharing resource request message is transmitted through the P2P direct connection in operation S307.

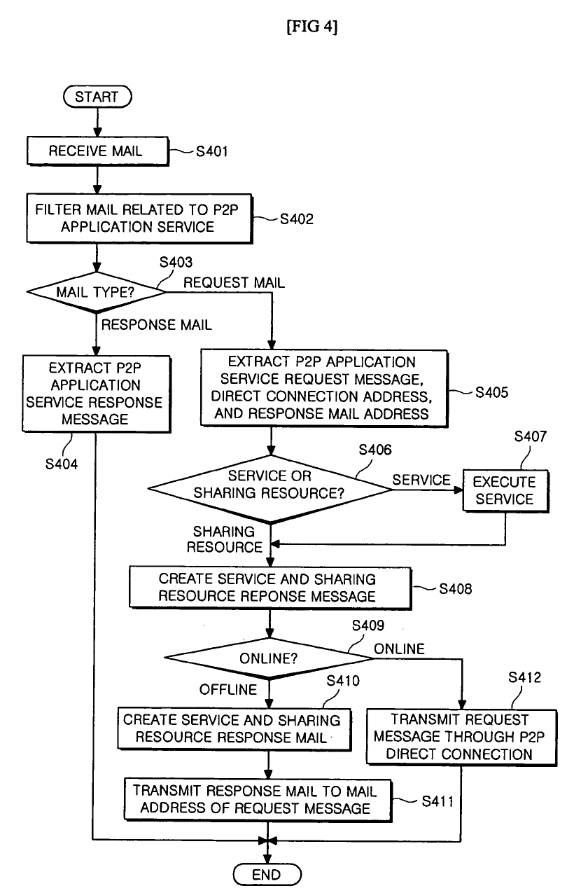

FIG. 4 is a flowchart illustrating a P2P service method using an E-mail service when a peer on the P2P network changes from offline state to online state. Referring to FIG. 4, when a peer requesting a specific service and sharing resource on the P2P network changes from offline state to online state, the peer receives E-mails from an E-mail server, which is previously set by a user, using POP3 or IMAP in operation S401.

An E-mail containing a header having a format defined by the corresponding P2P application service is filtered among the received E-mails in operation S402. That is, an E-mail containing a service and sharing resource request message related to the corresponding P2P application service is filtered. At this point, the E-mails are filtered according to whether an E-mail header defined by the P2P application service is contained in the E-mail.

In operation S403, a mail format of the filtered E-mail is checked to determine whether it is a request message or a response message for the specific service and sharing resource. When the filtered E-mail is the service and sharing resource response mail based on the format defined by the P2P application service, a response message is extracted in operation S404.

In some cases, when authentication information related to providing the service and sharing resource is contained, a relevant authentication procedure may be carried out. When the contents of the P2P E-mail are encrypted, a decryption procedure may be carried out.

In addition, when the peer providing the service and sharing resource on the P2P network changes from offline state to online state, the above-described operations S401 through S403 are carried out. Then, the service and sharing resource request message containing the P2P direct connection information of the requesting peer based on the format defined by the P2P application service and the E-mail address of the requesting peer is extracted from the request mail whose maximum response period has not passed in operation S405.

When it is determined from the extracted request message that the requested contents are the service in operation S406, the corresponding service is executed in operation S407.

In operation S408, the response message containing the execution result of the requested service and the sharing resource is created in accordance with the format defined by the P2P application service.

In operation S409, the peer tries the P2P direct connection to the peer sending the request message using the extracted P2P direct connection information and determines whether the peer is in online state or not.

When it is determined that the target peer is in offline state in operation S409, the peer creates an E-mail containing E-mail contents and an E-mail header having a format defined by the P2P application service in operation S410. The E-mail contents include the generated response message and the authentication information.

In operation S411, the created E-mail is transmitted to the extracted E-mail address of the requesting peer using SMTP.

When it is determined in operation S409 that the target peer is in online state, the created response message is transmitted through the P2P direct connection in operation S412.

The P2P service system and method using the E-mail service according to the embodiments of the present invention can provide a variety of P2P services (e.g., a message exchange, a file exchange, a remote control, etc.) to peers, which are in online state or temporarily in offline state, by using the E-mail in the P2P network environment which manages the connection information of the peers joined to the corresponding service or the indexes of the sharing resources.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A peer-to-peer service method, comprising:
advertising E-mail address information and service and sharing resource information through a peer-to-peer network at peers;
determining whether a peer requesting a service and a peer providing the service are in online state or in offline state on the peer-to-peer network; and
providing a peer-to-peer service through an E-mail server when the peer requesting the service or the peer providing the service is in offline state.

2. The peer-to-peer service method of claim 1, further comprising, prior to the advertising operation, registering an E-mail server address and a corresponding E-mail address at the respective peers on the peer-to-peer network.

3. The peer-to-peer service method of claim 1, wherein the E-mail address information and the service and sharing resource information are advertised when a corresponding peer-to-peer application service is initialized, contents of the service and sharing resource are changed, or there is a request from a user of the peer-to-peer application service.

4. The peer-to-peer service method of claim 1, wherein a specific service and sharing resource information is transmitted through a peer-to-peer direct connection when the peer requesting the service and the peer providing the service are in online state.

5. The peer-to-peer service method of claim 1, wherein when the peer requesting the service is in online state, an operation of requesting a specific service or sharing resource comprises:
searching a specific service or sharing resource advertisement on the peer-to-peer network;
determining whether a peer providing a service and sharing resource is in online state or in offline state by using a peer-to-peer direct connection address contained in the searched advertisement;
creating an E-mail having E-mail contents and an E-mail header defined in the peer-to-peer application service when the peer proving the service and sharing resource is in offline state, the E-mail contents including a service and sharing resource request message, peer-to-peer direct connection information of the peer requesting the service and sharing resource, an E-mail address of the peer requesting the service and sharing resource, and maximum response deadline information; and
transmitting the created E-mail to an E-mail address contained in the searched advertisement.

6. The peer-to-peer service method of claim 5, wherein the service and sharing resource request message is directly transmitted through the peer-to-peer direct connection when the peer providing the service and sharing resource is in online state.

7. The peer-to-peer service method of claim 1, further comprising:
downloading an E-mail from an E-mail server designated by a user to a local peer when the peer on the peer-to-peer network changes from offline state to online state;
filtering an E-mail containing an E-mail header defined by the corresponding peer-to-peer application service; and
extracting a request message or a response message for service and sharing resource request from the filtered E-mail, and extracting peer-to-peer direct connection information of the requesting peer and an E-mail address information of the requesting peer from the request message whose maximum response period has not passed.

8. The peer-to-peer service method of claim 7, wherein the extracting of the request message comprises:
performing an authentication procedure when authentication information related to providing the service and sharing resource is contained; and
performing a decryption procedure when peer-to-peer E-mail contents are encrypted.

9. The peer-to-peer service method of claim 7, further comprising, after the extracting of the request message:
executing a service when a requested content of the extracted request message is the service;
generating the response message containing the execution result of the requested service or the requested sharing resource;
determining whether the peer requesting the service and sharing resource is in online state or in offline state by using the peer-to-peer direct connection address information contained in the request message; and
generating the response message having an E-mail header and a mail format defined by the peer-to-peer application service when the peer requesting the service and sharing resource is in online state, and transmitting the generated response message to an E-mail address of the request message.

10. The peer-to-peer service method of claim 9, further comprising directly transmitting the response message through the peer-to-peer direct connection when the peer requesting the service and sharing resource is in online state.

11. A peer-to-peer service system, comprising:
a first peer for requesting service and sharing resource information provided on a peer-to-peer network;
a second peer for providing the requested service and sharing resource on the peer-to-peer network;
a first mail server for registering an E-mail address of the first peer, receiving the service and sharing resource transmitted from the second peer when the first peer is in offline state, and transmitting the service and sharing resource information to the first peer when the first peer changes from offline state to online state; and
a second mail server for registering an E-mail address of the second peer, receiving a requested mail from the first peer when the second peer is in offline state, and transmitting the requested mail to the second peer when the second peer changes from offline state to online state.

12. The peer-to-peer service system of claim 11, wherein the first peer and the second peer advertise service and sharing resource to be provided on the peer-to-peer network, peer-to-peer direct connection address information, and E-mail address information.

13. The peer-to-peer service system of claim 12, wherein the advertisement is generated and propagated when a corresponding peer-to-peer application service is initialized, the service and sharing resource to be provided on the peer-to-peer network is changed, or there is a request from a user of the peer-to-peer application service.

14. The peer-to-peer service system of claim 12, wherein the advertisement is propagated within a predetermined expiration time defined by the peer-to-peer application service.
